(19) United States
(12) Patent Application Publication
(10) Pub. No.: US 2024/0227919 A1
(43) Pub. Date: Jul. 11, 2024

(54) ELECTRO-MECHANICAL STEERING MECHANISMS AND RELATED METHODS

(71) Applicant: ATLIS MOTOR VEHICLES INC., Tempe, AZ (US)

(72) Inventors: Colin McKernan, Mesa, AZ (US); Derek Duff, Bradley, ME (US); Sean Conway, Mesa, AZ (US)

(73) Assignee: ATLIS MOTOR VEHICLES, Tempe, AZ (US)

(21) Appl. No.: 18/408,401

(22) Filed: Jan. 9, 2024

Related U.S. Application Data
(60) Provisional application No. 63/437,867, filed on Jan. 9, 2023.

(51) Int. Cl. B62D 5/04; B62D 5/00; H02K 7/06; H02K 21/16

(52) U.S. Cl. CPC B62D 5/0427; B62D 5/001; B62D 5/0445; H02K 7/06; H02K 21/16

(57) ABSTRACT

Implementations of a steering system may include: an arm configured to couple with a tie rod, the arm coupled through a journal bearing; a thrust bearing coupled to the journal bearing and to a nut; a screw rotatably coupled to an inverted planetary roller screw, the screw coupled with the nut; a rotor coupled to the nut and to a housing, the housing configured to be fixedly coupled to a frame; and a stator coupled to the housing and around the rotor and the inverted planetary roller screw where the stator is electrically coupled to a power source.

### CROSS REFERENCE TO RELATED APPLICATIONS

This document claims the benefit of the filing date of U.S. Provisional Patent Application 63/437,867, entitled “Systems and Methods for an Electro-Mechanical Steering Mechanism” to McKernan et al. which was filed on Jan. 9, 2023, the disclosure of which is hereby incorporated entirely herein by reference.

### BACKGROUND

### 1. Technical Field

Aspects of this document relate generally to vehicles, such as motor vehicles.

### 2. Background

Various vehicles have been devised to allow individuals to transport person or a wide variety of objects, liquids, or gases. Some vehicles are land vehicles and others travel on bodies of water or in the air. For vehicles that travel on land at least part of the time, wheels, belts, tracks, or skids are generally used to allow the vehicle to traverse the land surface.

### SUMMARY

Implementations of a steering system may include: an arm configured to couple with a tie rod, the arm coupled through a journal bearing; a thrust bearing coupled to the journal bearing and to a nut; a screw rotatably coupled to an inverted planetary roller screw, the screw coupled with the nut; a rotor coupled to the nut and to a housing, the housing configured to be fixedly coupled to a frame; and a stator coupled to the housing and around the rotor and the inverted planetary roller screw where the stator is electrically coupled to a power source.

Implementations of a steering system may include one, all, or any of the following:

Rotation of the inverted planetary roller screw and the nut may result in axial translation of the arm.

The journal bearing may be fixedly coupled to the housing.

The housing may prevent axial translation of the inverted planetary roller screw during rotation of the inverted planetary roller screw.

The nut may only rotate in a fixed axial position in the thrust bearing.

The stator and the rotor may include a frameless electric motor

The steering system may include a fly-by-wire steering system including a steering sensor, a processing circuit, memory, and a power converter configured to provide a drive signal to the frameless electric motor to generate translation of the arm in response to detecting movement of a steering wheel by the steering sensor.

Implementations of a steering system may include an arm coupled through an opening in a journal bearing and only axially slidable therein, the journal bearing coupled to a thrust bearing fixedly coupled to a nut. The steering system may include a screw rotatably coupled to an inverted planetary roller screw, the screw rotatably coupled with the nut; a rotor fixedly coupled to the nut; a housing; and a stator integrated with the housing and oriented around the rotor.

Implementations of a steering system may include one, all, or any of the following:

Rotation of the inverted planetary roller screw and the nut may result in only axial sliding of the arm through the opening in the journal bearing.

The journal bearing may be fixedly coupled to the housing.

The housing may prevent axial translation of the inverted planetary roller screw during rotation of the inverted planetary roller screw.

The nut may only rotate in a fixed axial position in the thrust bearing.

The stator and the rotor may include a frameless electric motor.

The steering system may include a fly-by-wire steering system including a steering sensor, a processing circuit, memory, and a power converter configured to provide a drive signal to the frameless electric motor to generate translation of the arm in response to detecting movement of a steering wheel by the steering sensor.

Rotation of the inverted planetary roller screw inside the nut may result in only axial sliding of the arm through the opening in the journal bearing.

Implementations of a steering system may include a steering sensor, a processing circuit, a memory, and a power converter electrically coupled with a frameless electric motor. The frameless electric motor further may include: a rotor coupled to a nut and to a housing, the housing configured to be fixedly coupled to a frame; and a stator coupled to the housing and around the rotor and an inverted planetary roller screw. The stator may be electrically coupled with the power converter and an arm configured to couple with a tie rod where the arm may be coupled with the inverted planetary roller screw.

Implementations of a steering system may include one, all, or any of the following:

Rotation of the inverted planetary roller screw inside the nut may result in axial translation of the arm.

The housing may prevent axial translation of the inverted planetary roller screw during rotation of the inverted planetary roller screw.

The steering system may be a fly-by-wire steering system.

The steering sensor, the processing circuit, memory, and the power converter may be configured to provide a drive signal to the frameless electric motor in response to detecting movement of a steering wheel by the steering sensor.

The foregoing and other aspects, features, and advantages will be apparent to those artisans of ordinary skill in the art from the DESCRIPTION and DRAWINGS, and from the CLAIMS.

### BRIEF DESCRIPTION OF THE DRAWINGS

Implementations will hereinafter be described in conjunction with the appended drawings, where like designations denote like elements, and:

FIG. 1 is an exploded view of an implementation of a steering system;

FIG. 2 is an exploded view of components of the implementation of the steering system of FIG. 1;

FIG. 3 is an exploded perspective view of an implementation of a frameless electric motor;

FIG. 4 is a front view of an implementation of a steering system in a center position;

FIG. 5 is a front view of an implementation of the steering system of FIG. 4 in a leftmost position;

FIG. 6 is a left side view of an implementation of the steering system of FIG. 4;

FIG. 7 is a partial see through front view of an implementation of a steering system with a housing removed;

FIG. 8 is a perspective view of an implementation of a steering system with a housing removed; and

FIG. 9 is a perspective diagram of an implementation of a steering system in a fly-by-wire configuration.

### DESCRIPTION

This disclosure, its aspects and implementations, are not limited to the specific components, assembly procedures or method elements disclosed herein. Many additional components, assembly procedures and/or method elements known in the art consistent with the intended steering systems will become apparent for use with particular implementations from this disclosure. Accordingly, for example, although particular implementations are disclosed, such implementations and implementing components may comprise any shape, size, style, type, model, version, measurement, concentration, material, quantity, method element, step, and/or the like as is known in the art for such steering systems, and implementing components and methods, consistent with the intended operation and methods.

In various vehicles, a rack and pinion assembly is used to convert rotations of a steering wheel into forces that pull or push on tie rods to orient the wheels of the vehicle left or right in order to steer the vehicle. Heavier vehicles require greater pushing and pulling forces on the tie rods to orient the tires due to both the larger size of the wheels and the higher weight of the vehicle. A rack and pinion assembly cannot provide the greater forces required for heavier vehicles because generating the greater forces overstresses and breaks the pinion portion of the assembly. To resolve this, heavier vehicles require steering systems such as worm and sector, worm and roller and recirculating ball steering systems. However, such heavier duty steering systems are large in size and generally result in a lot of play in the steering which makes the steering system less responsive to a given movement of a steering wheel.

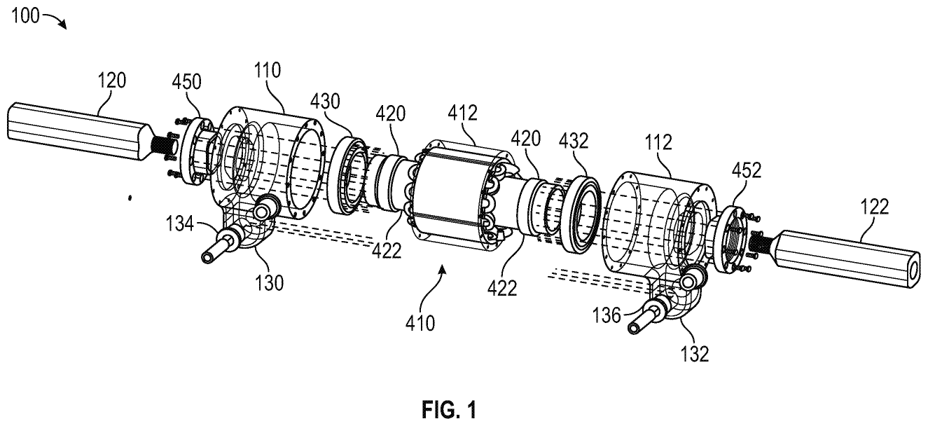

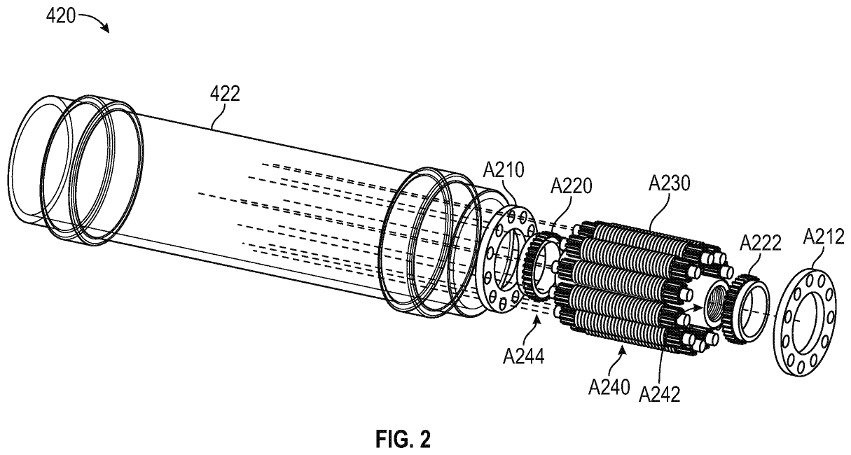

Referring to FIGS. 1 and 2, an implementation of an electro-mechanical steering system 100 is illustrated in an exploded view. The electro-mechanical steering mechanism 100, (steering mechanism 100), includes a frameless electric motor 410, an inverted planetary roller screw 420 and two thrust tapered roller bearings 430 and 432 (thrust bearings 430 and 432). The inverted planetary roller screw 420 includes a nut 422 and a screw A240 (see FIG. 2, not visible in FIG. 1) positioned inside the nut 422. The arm 120 and the arm 122 connect to the end A244 and the end A242 of the screw A240 (see FIG. 2). One end of nut 422 is inserted into the thrust bearing 430, while the other end of the nut 422 is inserted into the thrust bearing 432. The thrust bearings 430 and 432 are anchored, via mount 130 and 132, so that they are a fixed distance 440 away from each other. The mounts 130, 132 are ultimately attached to a frame of a vehicle (not shown in FIG. 1) to fixedly couple them in place. The thrust bearings 430 and 432 stop any axial or substantially any axial translation of the nut 422, so that when nut 422 rotates, the screw A240 then axially translates inside the nut 422 along the length of the nut 422, thus causing movement of the arms 120, 122 coupled thereto.

Referring to FIGS. 1 and 2, when the nut 422 rotates in a first direction (for example, clockwise), the screw A240 translates in a first direction (here, leftward) so that arm 120 further axially extends from the steering mechanism 100. As the arm 120 axially extends, the arm 122 correspondingly axially contracts into the steering mechanism 100. While the nut 422 rotates in a second direction (e.g., counterclockwise) opposite the first direction, the screw A240 translates in a second direction, opposite the first direction (here, rightward), so that the arm 122 axially extends from the steering mechanism 100 while arm 120 correspondingly axially contracts into the steering mechanism 100.

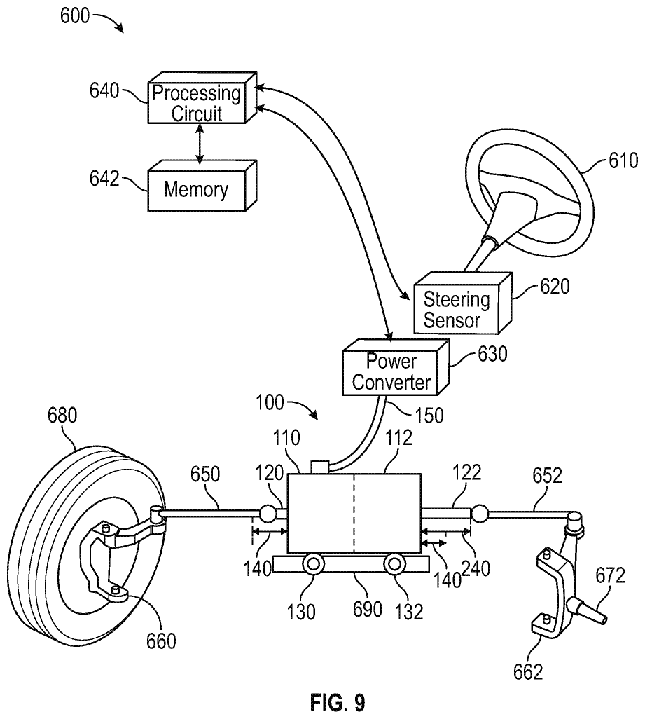

As illustrated in FIG. 9, the arms 120 and 122 connect to tie rods 650 and 652, respectively, through a direct connection or a linkage mechanism. Accordingly, as the arms 120 and 122 axially translate back and forth, they move the tie rods 650 and 652, the steering knuckles 660 and 662, and wheel spindles (not shown) to change the orientation of the wheel 680.

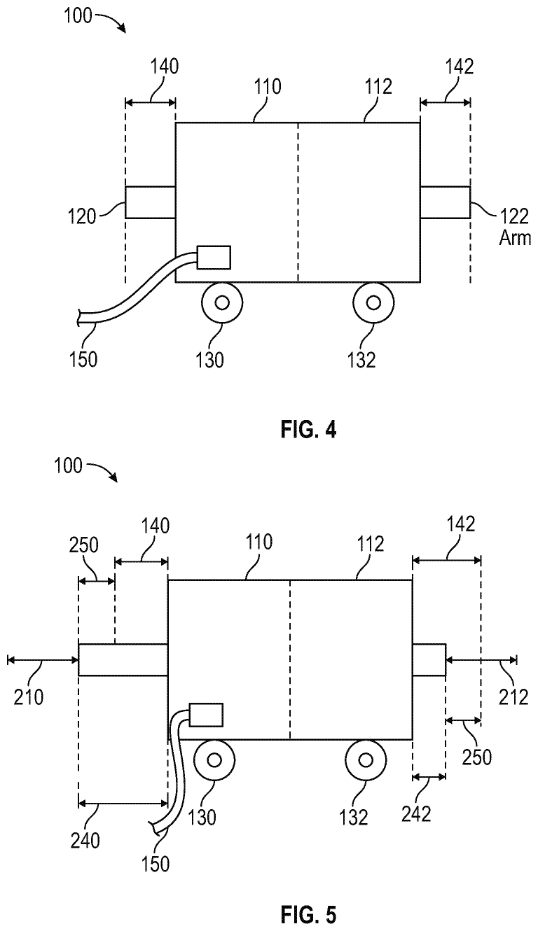

Referring to FIG. 4, an implementation of an electro-mechanical steering system 100 is illustrated. As illustrated, the steering mechanism 100 includes a housing 110 and 112, mounts 130 and 132, and arms 120 and 122. Housing 110 and 112 are configured to connect/couple to each other using bolts, screws, welds, etc. to form an integral housing to house the other components of the steering mechanism 100. The mounts 130 and 132 are used to fixedly connect/couple to housing 110 and 112. The mounts 130 and 132 also fixedly connect/couple to the frame 690 of the vehicle thereby fixing (mounting, holding) the steering mechanism 100 at a specific location with respect to the vehicle and the steering system (see system 600 in FIG. 9). As previously described, the arms 120 and 122 axially translate away from and toward the housings 110 and 112 (see forces 210, 212 in FIG. 5), or, in other words, away from and toward the fixed position of the steering mechanism 100. As previously described, the forces 2010, 212 applied by the arms 120 and 122 to the tie rods 650 and 652 is resisted by the frame 690 of the vehicle via the housings 110 and 112 and the mounts 130 and 132 which work to hold the steering mechanism 100 stationary and to thus ensure movement of the tie rods 650 and 652 and the wheel 680 (see FIGS. 5 and 9).

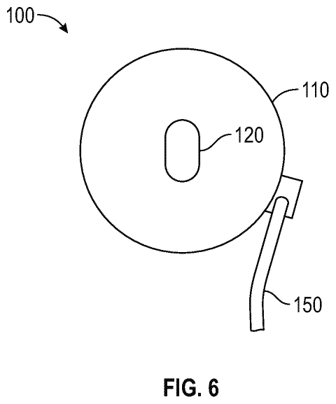

While not shown in FIG. 4 (and with reference to FIGS. 1-2), the housing 110 and 112 holds (contains/encloses) the frameless electric motor 410, the inverted planetary roller screw 420, the thrust tapered roller bearings 430 and 432, radial journal bearings 450 and 452, also referred to as journal bearings 430 and 432, and a varying portion of the arms 120 and 122. FIG. 6 shows an end on left-side view of the steering system 100 with arm 120 extending out of the paper and housing 110 and electrical connector 150 attached thereto. These various components of the system will be discussed further in this document.

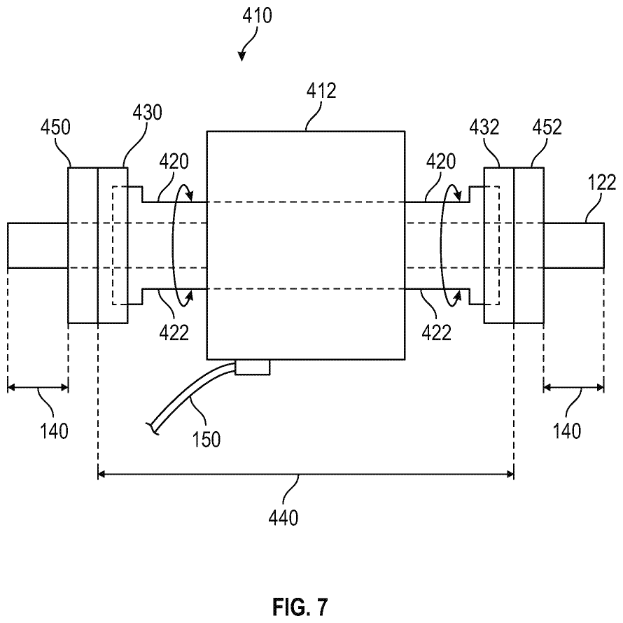

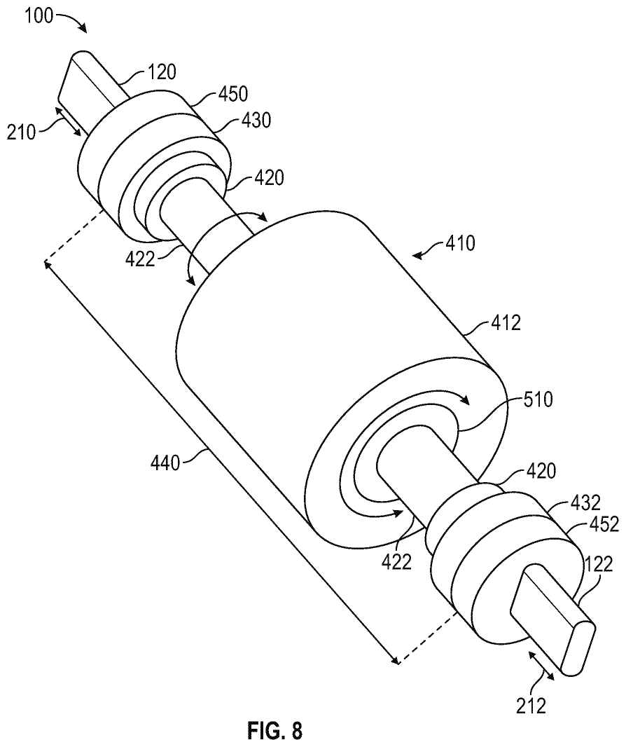

Referring to FIGS. 1, 5, 7, and 8, the arms 120 and 122 are positioned in holes/openings in the journal bearings 450 and 452 and in holes/openings in the housing 110 and 112, respectively. The distal end portions of the arms 120 and 122 extend from the housing 110 and the housing 112, respectively. The journal bearings 450 and 452 support the weight of the arms 120 and 122, respectively, during axial translational movement and the structure of the journal bearings is correspondingly aligned to permit axial movement. Translational movement means that the arms 120 and 130 move axially away from (out of) or toward (into) the housings 110 and 112, respectively.

Referring to FIG. 9, a distal end portion of each of the arms 120 and 122 mechanically connect to and provide a translational force 210, 212 (push, pull) to tie rod 650 and tie rod 652 respectively, as discussed previously. Referring to FIGS. 1-2, the proximate end portions of the arms 120 and 122 connect to the end A244 and the end A242, respectively, of the screw A240 positioned inside the nut 422 on each side of the inverted planetary roller screw 420. As the screw A242 moves back and forth (e.g., translates) inside the nut 422, the arms correspondingly move through the journal bearings 450 and 452 and into and out of the housings 110 and 112. Because the proximate end portions of the arms 120 and 130 are both connected to the screw A240, as the distal end portion of arm 120 moves a distance away from the housing 110, the distal end portion of arm 122 moves the same distance toward the housing 112 and vice versa.

As illustrated, the holes/openings in the journal bearings 450 and 452 and the holes in the housings 110 and 112 are not circular. As a result, the arms 120 and 122 have a non-circular portion/cross sectional shape that fits through the holes in the journal bearings 450 and 452 and the holes in the housings 110 and 112. Because the holes and the portions of the arms 120 and 122 that extend through the journal bearings 450 and 452 and out of the holes in the housings 110 and 112 are not round, the arms 120 and 122 are prevented from experiencing rotational movement. The arms 120 and 122 are allowed to only axially translate. While in FIG. 1 the shape of the opening in the journal bearings 450, 452 are illustrated to be in the form of a rounded square, in various implementations, many other cross sectional shapes may be used in various implementations, including, by non-limiting example, triangular, rectangular, elliptical, trapezoidal, polygonal, rounded versions of any of the foregoing, or any other cross sectional shape capable of preventing rotational movement of the arms in a correspondingly shaped opening in the journal bearings.

Referring to FIGS. 1, 7, and 8, the thrust bearings 430 and 432 are located adjacent to stator 412 positioned in the corresponding arm openings of housing 110 and 112, respectively (though housing 110, 112 is not illustrated in these figures, just the stator). When housing 110 is mechanically coupled to housing 112, the thrust bearing 430 is positioned a fixed distance 440 away from thrust bearing 432. As illustrated, the first end portion of nut 422 (first nut 422) are positioned in the thrust bearing 430. Correspondingly, the second end portion of nut 422 (second nut 422) is positioned in the thrust bearing 432. The thrust bearings 430 and 432 support the weight of the inverted planetary roller screw 420 during rotational movement. When the steering mechanism 100 is assembled, the housing 110 and 112 fix the distance between the thrust bearing 430 and 432 at the distance 440, so the nut 422 of the inverted planetary roller screw 420 cannot axially translate (and the screw 420 cannot axially translate either). Because of this mechanical boundary condition, the nut 422 can only rotate along with inverted planetary roller screw 420.

In particular implementations, the thrust bearings 430 and 432 are thrust tapered roller bearings. Due to the roller bearing construction, the thrust bearings 430 and 432 may have great strength and be able to withstand high forces during use over extended periods of time without breaking. Further, tapered roller bearings can act to reduce rotational resistance, thereby increasing the efficiency of transfer of force from the rotating nut 422 to the screw A240 and correspondingly to the arms 120 and 122.

Referring to FIG. 2, an implementation of an inverted planetary roller screw 420 is illustrated. As previously discussed, the inverted planetary roller screw 420 is positioned inside housing 110 and 112. As illustrated, the inverted planetary roller screw 420 includes carrier rings A210 and A212, aligning gears A220 and A222, a plurality of planetary screws A230 and screw 240, all of which are positioned inside the nut 422 on each side of the inverted planetary roller screw 420.

The screw A240 includes end A244 and end A242. The aligning gears A220 and A222 and the carrier rings A210 and A212 positioned at each end hold the plurality of the planetary screws A230 around a circumference of the screw A240. Carrier rings A210 and A212 position the plurality of planetary screws A230 so that they can rotate while simultaneously remaining in position around the screw A240. The aligning gears A220 and A222 interact with the ends of the plurality of the planetary screws A230 to assist the plurality of planetary screws with rotating. As illustrated in FIG. 2, the outer surface of each planetary screw of the plurality of planetary screws A230 is threaded.

While not directly illustrated in the figures, the inside/inner surface of the nut 422 is also threaded. FIG. 2 illustrates how the nut 422 takes the form of a tube into which the screw and the planetary screws A230 fit. The pitch, thread angle, depth, diameter and helix angle of the threads on the inner surface of the nut 422 are selected to correspond with to the pitch, thread angle, depth, diameter and helix angle of the threads on each planetary screw of the plurality of planetary screws A230. Because the characteristics of the threads on the inside of the nut 422 correspond with the characteristics of the threads on the planetary screws of the plurality of planetary screws A230, the threads of the nut 422 smoothly mesh with the threads on the plurality of planetary screws A230. The aligning gears A220 work to maintain the position of the threads of the plurality of planetary screws A230 during rotation so that the threads of the plurality of planetary screws A230 align and mesh with the threads on the inside of the nut 422 as the nut 422 and the plurality of planetary screws A230 rotate relative to one another.

As discussed above, the proximate end portion of the arm 120 mechanically connects with/fixedly couples the end A244 of the screw A240. The proximate end portion of the arm 122 mechanically connects with/fixedly couples the end A242 of the screw A240. However, as discussed above, the distal end portion of the arms 120 and 122 are not round but have a substantially rectangular shape that fits through the hole in the journal bearings 450 and 452 which are mechanically fixed to/into the housing 110 and 112, respectively, so that they cannot rotate. The shape of the holes in the journal bearings 450 and 452 further stops the arms 120 and 122 from rotating. Because the arms 120 and 122 cannot rotate, the connection of the proximate ends of the arms 120 and 122 to the screw A240 stops the screw A240 from rotating.

Because the arms cannot rotate, as the nut 422 rotates around the screw A420, the force from the rotation of the nut 422 would otherwise cause the screw A240 to rotate if rotation were not stopped by the fixed coupling of the ends of the screw with the arms 120 and 122. Thus, since the screw A240 cannot rotate, the threads on the planetary screws of the plurality of planetary screws A230 that mesh with the threads on the inside of the nut causes the screw A240 to translate axially back and forth inside the nut 422. As the nut rotates in the first direction (e.g., clockwise), the screw A240 axially translates in the first direction (e.g., leftward) inside the nut 422 until it reaches the end of the nut 422. As the nut 422 axially translates in the first direction, one arm (here arm 120) further extends away from the housing while the other arm (here arm 122) contracts into the housing. As the nut axially translates in the second direction (counterclockwise), the screw A240 translates in the second direction (leftward), opposite the first direction, inside the nut 422 until it reaches the other end of the nut 422. As the nut 422 translates in the second direction (here clockwise), one arm (arm 122) further extends away from the housing while the other arm (arm 120) contracts into the housing.

The plurality of planetary screws A230 significantly strengthens the inverted planetary roller screw 420 by spreading stress among the plurality planetary screws A230 thereby enabling the arms 120 and 122 to deliver a significant amount of translational force to the tie rods 650 and 652 via the arms 120, 122. The inverted planetary roller screw 420 can deliver significantly more translation force (in various implementations, many times more, about 50 kN versus about 15 kN) for pushing or pulling against the tie rods 650 and 652 when compared with a rack and pinion steering system. The significant force provided by the inverted planetary roller screw 420 can make the steering mechanism 100 implementations disclosed herein suitable for use in steering systems of heavy vehicles. Further, the rollers used in the inverted planetary roller screw 420 increase the durability and operating life of the inverted planetary roller screw 420 and thereby the steering mechanism 100.

Further, because the design is an inverted planetary screw, the longer length of the nut 422 increases the distance of travel of the screw A240 thereby enabling the arms 120 and 122 to extend from and contract into the housing a much greater distance than in a planetary screw design. However, even with the increased length of the nut, the overall length of the inverted planetary roller screw 420 is at least 40% shorter than using a planetary screw.

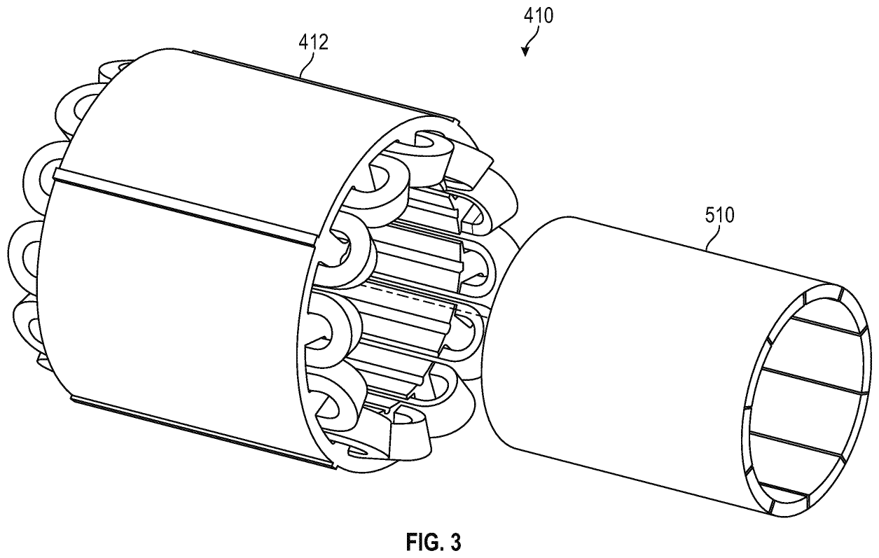

The foregoing sections have discussed mechanical portions of the system. In various steering system implementations, electrical energy in the form of electrical field may be used to provide the force that drives the movement of the nut and correspondingly the inverted planetary roller screw 420 and arms 120, 122. Referring to FIGS. 1, 3, 7, and 8, in various implementations, a frameless electric motor 410 may be utilized. As illustrated in FIG. 3, the frameless electric motor 410 includes stator 412 and a rotor 510. The stator 412 is held stationary in the housing 110 and 112 through being coupled thereto. The frame 690 of the vehicle operates to hold the housing 110 and 112 stationary, via mounts 130 and 132, which in turn holds the stator 412 stationary. The rotor 510 of the frameless electric motor 410 rotates responsive to the electric field created by the stator 412.

The rotor 510 is mechanically affixed to/fixedly coupled with the nut 422 of the inverted planetary roller screw 420. In particular implementations, the permanent magnets of the rotor 510 are affixed to the outside/outer surface of the nut 422. Accordingly, responsive to electric field created by the stator 412 and the rotor 510, force is applied to the nut 422 which, in response, rotates. The stator 412 receives electrical energy for creating the electric field via the electrical connector 150 (see FIG. 6). An electrical signal having a first characteristic causes the rotor 510, and thus the nut 412, to rotate in the first direction (clockwise). An electrical signal having a second characteristic causes the rotor 510, and thus the nut 412, to rotate in the second direction (counterclockwise). As the rotor 510 and the nut 422 rotate in the first direction and the second direction, the screw A240 and the arms 120 and 122 axially translate back and forth with respect to the housing 110 and 112.

Referring to FIG, 9, the frameless electric motor can 410 adapt the steering mechanism 100 for operation in a fly-by-wire steering system. As illustrated, the steering sensor 620, the processing circuit 640 and the power converter 630 may detect and convert mechanical movement from steering wheel 610 into electrical signals of a drive signal that causes the rotor 510 and thus the nut 412 to translate in the first direction and the second direction.

In a particular implementation, the steering mechanism 100 includes sensors for detecting when the screw A240 has translated to either end of the nut 422. While the screw A240 is translating in the first direction, a first proximity sensor (not shown) detects that the screw A240 has reached the first end of the nut 422. Upon the first proximity sensor detecting that the screw A240 has reached the first end of the nut 422, the first proximity sensor sends a signal to the frameless electric motor 410 (or to the processing circuit 640), so that frameless electric motor 410 ceases translating the screw A240 in the first direction. While the screw A240 is translating in the second direction, a second proximity sensor (not shown) detects that the screw A240 has reached the second end of the nut 422. Upon the second proximity sensor detecting that the screw A240 has reached the second end of the nut 422, the second proximity sensor sends a signal to the frameless electric motor 410 (or to the processing circuit 640), so that frameless electric motor 410 ceases translating the screw A240 in the second direction. A wide variety of proximity sensors may be employed in various implementations, including, by non-limiting example, Hall effect sensors, optical sensors, ultrasonic sensors, limit sensors, or any other positional sensor type. Furthermore, in various implementations, the proximity sensor(s) may be capable of providing continuous output rather than limit input so that the processing circuit and/or frameless electric motor 410 is able to calculate the exact position of the nut (and thus the wheels at a given axial translation.

Using a frameless electric motor makes the steering mechanism 100 smaller, and, in particular, shorter then using a framed electric motor. Lacking a frame, the stator 412 may be integrated into/built into the housing 110 and 112. The stator 412 may encircle and be coaxially positioned with respect to the inverted planetary roller screw 420. The rotor 510 may also encircle and be coaxially positioned with the inverted planetary roller screw 420 by being at least partially incorporated (magnet attachments) into the structure of the nut 422. The frameless electric motor 100 thus shortens the length of the steering mechanism 100 and may decrease the diameter of the steering mechanism 100 in particular implementations.

Again referring to FIG. 9, an implementation of a steering mechanism 100 is illustrated incorporated into a fly-by-wire steering system 600. As illustrated, steering system 600 includes a steering wheel 610, a steering sensor 620, a processing circuit 640, a memory 642, a power converter 630, tie rods 650 and 652, steering knuckles 660 and 662, wheel spindles, wheel 680, and frame 690. While not shown in FIG. 9 for better illustration, a correspondingly wheel is attached to steering knuckle 662.

During operation, a user of the vehicle rotates the steering wheel 610 to steer the vehicle. The steering sensor 620 detects the rotations of the steering wheel 610 and reports the rotations to the processing circuit 640. The processing circuit 640 converts the signals from the steering sensor 620 into a drive signal(s) that operates the frameless electric motor 420 via the power converter 630. The power converter 630 provides signals suitable for the stator 412 for causing the rotor 510 to rotate in the first direction or the second direction. The power converter 630 may also provide signals that cause the stator 412 to hold the rotor 510 in its current position assuring a stable position for the wheels. In some implementations, the signals that cause holding of the rotor 510 may be alternating polarity voltage/current signals at a predetermined frequency. The processing circuit 640 may also receive signals from sensors, such as the proximity sensors discussed previously, that are used to alter/affect the signals sent to the power converter 630 and the frameless electric motor 410.

As illustrated in FIG. 9, the steering mechanism 100 mechanically mounts to frame 690 using mounts 130 and 132. The frame 690 holds the steering mechanism 100 stationary with respect to the tie rods 650 and 652, the steering knuckles 660 and 662 and the wheel 680. Because the steering mechanism 100 is held stationary with respect to the other components of the steering system 600, translations of the arm 120 and 122 cause movement in the tie rods 650 and 652, and steering knuckles 660 and 662. The movements of the tie rods 650 and 652, and steering knuckles 660 and 662 orient the wheel 680 to steer the vehicle.

The frame 690 thus holds the housing 110 and 112 stationary. The housing 110 and 112 in turn holds the journal bearing 450, the thrust bearing 430, the stator 412, the thrust bearing 432, and the journal bearing 452 so that these components cannot axially translate. The thrust bearings 430 and 432 in turn hold the nut 422 so that it too cannot axially translate but can rotate. As discussed above, the rotations of the rotor 510 cause the screw A240 and the arms 120 and 122 to axially translate back and forth.

The arm 120 and the arm 122 connect to the tie rod 650 and the tie rod 652 respectively. The tie rods 650 and 652 are connected to the steering knuckles 660 and 662 respectively. The wheel spindle 670 of the steering knuckle 660 is connected to the wheel 680.

Translation of the arm 120 away from the housing 110 and translation of the arm 122 toward the housing 112 at the same time causes the arm 122 push on the tie rod 650 and the arm 122 to pull on the tie rod 652 which in turn causes the wheel 680 to change orientation in a leftward direction from the perspective of the driver. Translation of the arm 120 toward the housing 110 and translation of the arm 122 away from the housing 112 at the same time causes the arm 120 to pull on the tie rod 650 and the arm 120 to push on the tie rod 652 which in turn causes the wheel 680 to change orientation in a rightward direction from the perspective of the driver. The arm 120 and 122 may cease translating and hold their present position thereby holding the tie rods 650 and 652 at their present position and thereby the wheels of the vehicle at their present orientation.

While in the implementations disclosed herein the use of two arms and two wheels for steering is illustrated, a single arm can be used to change the angle of a single wheel as in a tricycle vehicle configuration. In these implementations, the same steering structure is utilized, but only one arm extends from the housing (and only one journal bearing may thus be needed).

As illustrated in FIG. 9, arm 120 has axially translated to its position closest toward the housing 110 while arm 122 has axially translated to its position furthest away from the housing 112. In these respective positions, the arms 120 and the arm 122 have pulled and pushed the tie rod 650 and the tie rod 652 respectively to orient the wheel 680 and the corresponding wheel in their rightmost orientation from the perspective of the driver. In these positions, the steering system 600 steers the vehicle in its rightmost turn.

The arm 120 may axially translate away from the housing 110 while at the same time the arm 122 translates toward the housing 112 to push and pull the tie rod 650 and the tie rod 652 respectively to orient the wheel 680 and the corresponding wheel away from their rightmost orientation. When the arm 120 and the arm 122 reach their central position, best seen in FIG. 4 with the arm 120 at the displacement 140 and the arm 122 at the displacement 142, the arm 120 and the arm 122 position the tie rods 650 and 652 so that the wheels 680 and 682 are oriented in a forward direction.

Referring to FIG. 5, from the central position, the arm 120 may continue to axially translate away from the housing 110 while at the same time the arm 122 continues to axially translate toward the housing 112 to push and pull the tie rod 650 and the tie rod 652 respectively to orient the wheel 680 and the wheel 682 in a leftward direction from the perspective of the driver. The arm 120 may continue to axially translate away from the housing 110 while at the same time the arm 122 continues to axially translate toward the housing 112 until the arm 120 reaches its furthest position, the translation 240 (about two hundred mm in a particular implementation), away from the housing 110, and the arm 122 reaches its closest position, the translation 242, toward the housing 112. In these positions, the arm 120 has pushed and the arm 122 has pulled the tie rod 650 and the tie rod 652 respectively so that the wheels 680 and 682 are positioned in their leftmost orientation from the perspective of the driver. In these positions, the steering system 600 steers the vehicle in its leftmost turn.

While the foregoing implementations have been described as being used with a frameless electric motor, it is possible to implement the mechanical portions of the steering system implementations disclosed herein using mechanical drive systems. In such implementations, the frameless electric motor 410 is replaced by a mechanical mechanism like a worm gear or multiple parallel worm gears that rotate the nut 422 to translate the arms 120 and 122 to move the tie rods 650 and 652 to orient the wheels 680 and 682 to steer the vehicle. A mechanical link between the steering wheel 610 and the mechanical mechanism that rotates the worm gear(s) to turn the nut 422 enables the user to turn the steering wheel and thereby the nut 422 to steer the vehicle. Threads on the exterior surface of the nut 422 would mesh with the threads of the worm gear(s) for the worm gear(s) to be able to rotate the nut 422. In such systems, the size reduction derived from the use of an inverted planetary roller screw may be achieved with the use of a worm gear (worm drive) mechanical system. In these implementations, however, the worm gear(s) may be the weak link in the system and may limit the mechanical force that the steering system can apply to the arms and wheels.

The various electro-mechanical steering systems disclosed herein may provided various advantages. These electro-mechanical steering implementations include a frameless electric motor, an inverted planetary roller screw, two thrust tapered roller bearings, and two radial journal bearings that can produce the forces needed to move tie rods to steer vehicles including heavy vehicles. Use of the inverted planetary roller screw, as opposed to using a roller screw, reduces the length of the steering system, increases the range of motion of the screw, and facilitates integrating the frameless electric motor. A shorter (less in length or width) steering system allows the tie rods to be longer which can improve roll-steer and bump-steer performance significantly. A frameless electric motor allows the motor to be positioned coaxially with the axis of the inverted planetary roller screw, thereby further reducing the overall length of the steering mechanism, reducing the size of the steering mechanism (diameter, girth) and potentially reducing the complexity of the casting. Further, the frameless electric motor can enable the steering mechanism to be easily incorporated into a fly-by-wire steering system which does not use a direct mechanical coupling of the steering wheel with the wheels being steered.

Also, due to the ability of the inverted planetary roller screw 420 to handle high mechanical load forces, the arms 120 and 122 may be able to provide significantly more translational force (forces 210, 212 illustrated in FIG. 5) for moving (or pushing, pulling) tie rods 650 and 652 than a rack and pinion steering system can provide and at least as much as, if not more, force than all other types of steering systems disclosed herein, thus making the steering mechanism 100 suitable for most types of vehicles including heavy vehicles.

Because the steering mechanism 100 is shorter in length than the other types of steering systems disclosed herein, it is also suitable for use in a rear-wheel steering system. In such implementations, the length of the inverted planetary roller screw 420, and, in particular, the nut 422, may be shortened so that the range of translation of the arm 120 and 122 is decreased so that the rear wheels steer at a fraction of the change in orientation of the front wheels. In other implementations, the frameless electric motor 410 can utilize the steering mechanism 100 for both the front steering system and the back steering system under mutual control by a microprocessor or other processing circuit.

The frameless electric motor 410 may be used to rotate the nut 422 to perform the steering. The frameless electric motor 410 may also make the steering mechanism 100 easier to integrate into a fly-by-wire steering system such as the example embodiment shown in FIG. 6.

In places where the description above refers to particular implementations of steering systems and implementing components, sub-components, methods and sub-methods, it should be readily apparent that a number of modifications may be made without departing from the spirit thereof and that these implementations, implementing components, sub-components, methods and sub-methods may be applied to other steering systems.

What is claimed is:

1. A steering system comprising:
an arm configured to couple with a tie rod, the arm coupled through a journal bearing;
a thrust bearing coupled to the journal bearing and to a nut;
a screw rotatably coupled to an inverted planetary roller screw, the screw coupled with the nut;
a rotor coupled to the nut and to a housing, the housing configured to be fixedly coupled to a frame; and
a stator coupled to the housing and around the rotor and the inverted planetary roller screw, the stator electrically coupled to a power source.

2. The steering system of claim 1, wherein rotation of the inverted planetary roller screw and the nut results in axial translation of the arm.

3. The steering system of claim 1, wherein the journal bearing is fixedly coupled to the housing.

4. The steering system of claim 1, wherein the housing prevents axial translation of the inverted planetary roller screw during rotation of the inverted planetary roller screw.

5. The steering system of claim 1, wherein the nut can only rotate in a fixed axial position in the thrust bearing.

6. The steering system of claim 1, wherein the stator and the rotor comprise a frameless electric motor.

7. The steering system of claim 6, further comprising a fly-by-wire steering system comprising a steering sensor, a processing circuit, memory, and a power converter configured to provide a drive signal to the frameless electric motor to generate translation of the arm in response to detecting movement of a steering wheel by the steering sensor.

8. A steering system comprising:
an arm coupled through an opening in a journal bearing and only axially slidable therein, the journal bearing coupled to a thrust bearing fixedly coupled to a nut;
a screw rotatably coupled to an inverted planetary roller screw, the screw rotatably coupled with the nut;
a rotor fixedly coupled to the nut;
a housing; and
a stator integrated with the housing and oriented around the rotor.

9. The steering system of claim 8, wherein rotation of the inverted planetary roller screw and the nut results in only axial sliding of the arm through the opening in the journal bearing.

10. The steering system of claim 8, wherein the journal bearing is fixedly coupled to the housing.

11. The steering system of claim 8, wherein the housing prevents axial translation of the inverted planetary roller screw during rotation of the inverted planetary roller screw.

12. The steering system of claim 8, wherein the nut can only rotate in a fixed axial position in the thrust bearing.

13. The steering system of claim 8, wherein the stator and the rotor comprise a frameless electric motor.

14. The steering system of claim 13, further comprising a fly-by-wire steering system comprising a steering sensor, a processing circuit, memory, and a power converter configured to provide a drive signal to the frameless electric motor to generate translation of the arm in response to detecting movement of a steering wheel by the steering sensor.

15. The steering system of claim 8, wherein rotation of the inverted planetary roller screw inside the nut results in only axial sliding of the arm through the opening in the journal bearing.

16. A steering system comprising:
a steering sensor, a processing circuit, a memory, and a power converter electrically coupled with a frameless electric motor wherein the frameless electric motor further comprises:
a rotor coupled to a nut and to a housing, the housing configured to be fixedly coupled to a frame; and
a stator coupled to the housing and around the rotor and an inverted planetary roller screw, the stator electrically coupled with the power converter; and
an arm configured to couple with a tie rod, the arm coupled with the inverted planetary roller screw.

17. The steering system of claim 16, wherein rotation of the inverted planetary roller screw inside the nut results in axial translation of the arm.

18. The steering system of claim 16, wherein the housing prevents axial translation of the inverted planetary roller screw during rotation of the inverted planetary roller screw.

19. The steering system of claim 16, wherein the steering system is a fly-by-wire steering system.

20. The steering system of claim 16, wherein the steering sensor, the processing circuit, memory, and the power converter are configured to provide a drive signal to the frameless electric motor in response to detecting movement of a steering wheel by the steering sensor.
